(19) United States
(12) Patent Application Publication
(10) Pub. No.: US 2007/0213859 A1
(43) Pub. Date: Sep. 13, 2007

(54) Method and computer for playing instant music

(75) Inventor: Cheng-Hsun Li, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/714,251

(22) Filed: Mar. 6, 2007

(30) Foreign Application Priority Data
Mar. 7, 2006 (TW) 95107629

(51) Int. Cl. G06F 17/00

(52) U.S. Cl. 700/94

(57) ABSTRACT

A method for playing instant music comprises the steps of: generating a hardware time by reading a real time clock (RTC); determining whether the hardware time meets a predetermined start-up time or not; if positive, executing a BIOS; determining whether a CD instant playing module of the BIOS is started or not; if positive, initiating an optical disc drive and an audio module; and playing the optical disc drive.

### FIELD OF THE INVENTION

The present invention relates to a computer, more particularly to a method and a computer for playing instant music.

### BACKGROUND OF THE INVENTION

With the continuing advances and developments of electrical manufactures, the multimedia computers in new generation with high quality are widely used and more popular. The expenditure enhancement for computers also causes the popularization and more vigorous development of peripheral products. The peripheral as hard disc drive, optical disc drive, scanner, printer, etc. are introduced to enhance and expand variable functions of computers for providing users more conveniences.

The optical disc drive is a convenient and popular device due to the enormity storage capacity of the compact discs (CDs), and further that of the data containing music or the image formats being long-term preserved. Especially, following the performance promotion of the peripheral as audio chips, speakers, etc., the computer can provide good tone quality when playing the audio CDs. Therefore, some users adopt the computers to listen to music or speech audios.

However, since the optical disc drives are peripheral apparatus of computer systems, the operation systems (OS) shall be loaded first and then the related playing programs are executed to drive the optical disc drives and audio chips for playing music and vocals. However, it is inconvenient to that the users only listen to music or vocals since starting the computers takes too much time. Comparatively, the conventional CD player is more convenient for simple procedures. Besides, when the booting sequence is done, all devices of the system are remained in the stand-by mode, and it causes extra electrical consumption.

For overcoming above inconveniences, in some current designs, some of the computers may play music and vocal CDs without loading operation systems. Namely, the module and programs in BIOS can directly drive the optical disc drive, the audio chip, and the keyboard to play music and vocal CDs in a lower consumption mode for saving power.

As aforesaid, the users can operate the optical disc drives to read CDs by pressing some keys located on the general keyboard and playing through the audio chips and speakers. In general, the users have to predetermine the keys of “playing optical disc drive function” firstly, and then they can use these predetermined keys to operate the optical disc drive after the computers are booted partially to have the functions as “play”, “forward”, “next”, “stop/eject”, “volume up”, “volume down”, “turn off”, etc.

Although the playing functions of above optical disc drives solve the complicated problems of loading the OSs in computers. But, on the users' side, the computers not only play music, but also provide the same functions as hi-fi equipment, which tends to replace general household audio-video equipment. There is one function, called alarm, equipped in the household audio-video equipment. That is, the users are able to set the predetermined start-up time, music, and radio channels in advance.

Therefore, a computer is equipped with a hi-fi equipment so as to save the cost to purchase a brand new hi-fi equipment and the spaces to place it. The user can then listen a great music at the beginning of a day without the high-frequency noise.

Hence, in order to let the user listen to the music for waking up at the beginning of the day by way of the computer and improve the functions to play music and vocals in the computer for customer demands, an advanced technology for the computer playing such CDs, MP3 , etc. may be developed and an important issue for persons skilled in the art.

### SUMMARY OF THE INVENTION

The primary objective of the present invention is to provide to a method for playing instant music. That is, a computer is timely booted to play a music or vocal CD before loading an operation system.

To reach above objective, this invention discloses the method for playing instant music comprising the steps of: generating a hardware time by reading a real time clock(RTC); determining whether the hardware time meets a predetermined start-up time or not; executing a BIOS, if the hardware time meets the predetermined start-up time; after the BIOS being executed, determining whether a CD instant playing module of the BIOS is started or not; and if the CD instant playing module is ready, initiating an optical disc drive to play the music CD.

Above steps of determining whether the hardware time meets a predetermined start-up time or not, if positive, executing a BIOS further comprises determining whether an optional function of an RTC alarm power on module is started or not, then determining whether the CD instant playing module of the BIOS is started or not, while the CD instant playing module is not started, initiating system procedure and loading an operation system (OS) are then engaged in, and then the hardware time and the predetermined start-up time are stored in a CMOS and the predetermined start-up time is input by the BIOS.

Besides, the CD instant playing module is a set of programs providing a driver of the optical disc drive, the instant playing module is part of the BIOS, and there is an option in the BIOS to execute the CD instant playing module.

Further, above step of determining whether the hardware time meets the predetermined start-up time or not, if positive, the BIOS is then started, and further an instruction is delivered to wake up a CPU and a chipset, continuously determining whether the hardware time meets the predetermined start-up time or not is processed under an S5 power-saving mode.

A computer applied to play a disc comprises a real time clock (RTC), an optical disc drive, a BIOS, a storing module, and a control module. The RTC generates a hardware time. The BIOS has an RTC alarm power on module and a CD instant playing module, and the BIOS controls the RTC alarm power on module and the CD instant playing module, wherein a predetermined start-up time is set in the RTC alarm power on module, and the CD instant playing module further comprise a driver. The storing module is for storing the BIOS and the predetermined start-up time. The control module drives the optical disc drive for playing the disc under the condition of the hardware time meeting the predetermined start-up time. Wherein the storing module is a CMOS and the control module is a South Bridge Chip.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a flow diagram of a method for playing instant music in a preferred embodiment of the present invention, and

FIG. 2 is a block diagram of a method for playing instant music in the preferred embodiment of the present invention.

### DETAILED DESCRIPTIONS OF THE PREFERRED EMBODIMENT

The preferred embodiment of the present invention discloses a method for playing instant music, and applies to an computer. The purpose of the preferred embodiment of the present invention is to let a computer be timely booted to play a music or vocal CD before loading an operation system.

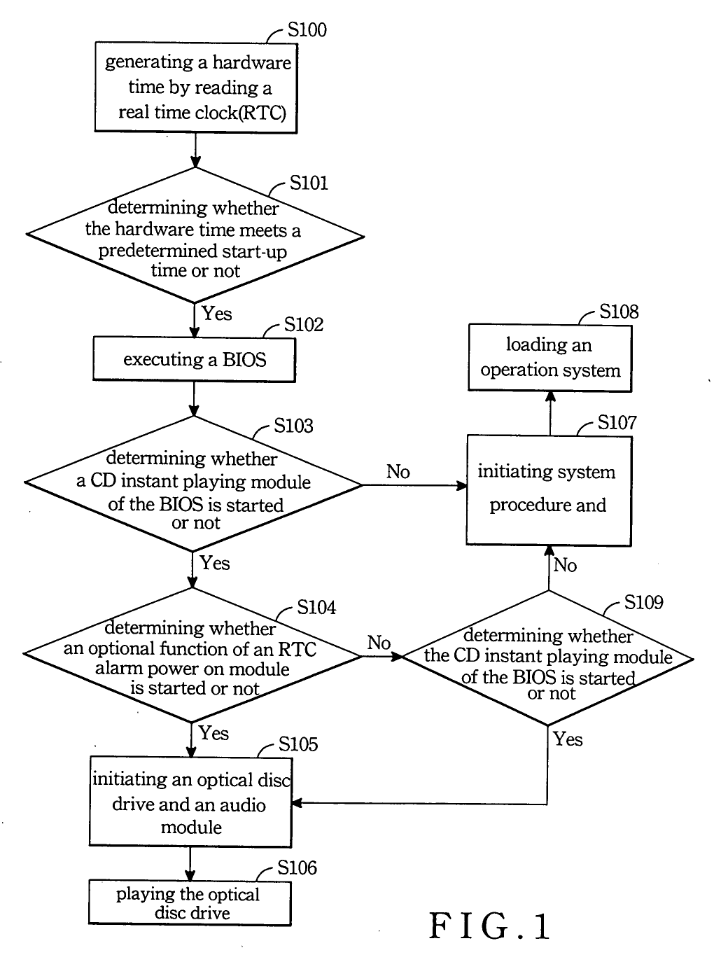

Referring to FIG. 1, which illustrates a flow diagram of a method for playing instant music in the preferred embodiment of the present invention. In the step S100, a real time clock (RTC) is read by the computer for generating a hardware time since most computer clock information sources is from the RTC in general.

In the step S101, the computer determines whether the hardware time meets a predetermined start-up time or not. In this embodiment, the predetermined start-up time can be set via a BIOS which can show a setting menu by a user, and the predetermined start-up time and the hardware time are stored in the CMOS of the computer. When the hardware time meets the predetermined start-up time, the computer executes the BIOS (S102).

In the step S103, the computer determines whether a CD instant playing module of the BIOS is started or not after the BIOS is executed. In the step S104, the computer determines whether an optional function of an RTC alarm power on module of the BIOS is started or not if the CD instant playing module is ready. In the step S105, the computer initiates an optical disc drive of the computer and an audio module of the computer if the RTC alarm power on module is also ready. Thereafter, the computer plays the optical disc drive (S106).

In the step S103, if the CD instant playing module is not started, then the step S107 is executed so that the computer executes a system initiating procedure. Thereafter, the computer loads an operation system (OS) (S108).

Besides, in the step S104, if the RTC alarm power on module is not started, the computer determines whether the CD instant playing module of the BIOS is started or not (S109). If the CD instant playing module is not started, the computer executes the step S107 and the step S108.

In the step S109, if the CD instant playing module is ready, the computer executes the step S105 and the step S106 to play the optical disc drive.

It should be noted that, the step S101 is processed under an S5 (Soft Off) power-saving mode and the BIOS can issue an instruction to wake up a CPU and a chipset of the computer to read data, programs which the computer needs or to operate the corresponding chipset. In this embodiment, the S5 power-saving mode indicates that the computer state where the computer consumes a minimal amount of power. Further, no user mode or system mode code is run.

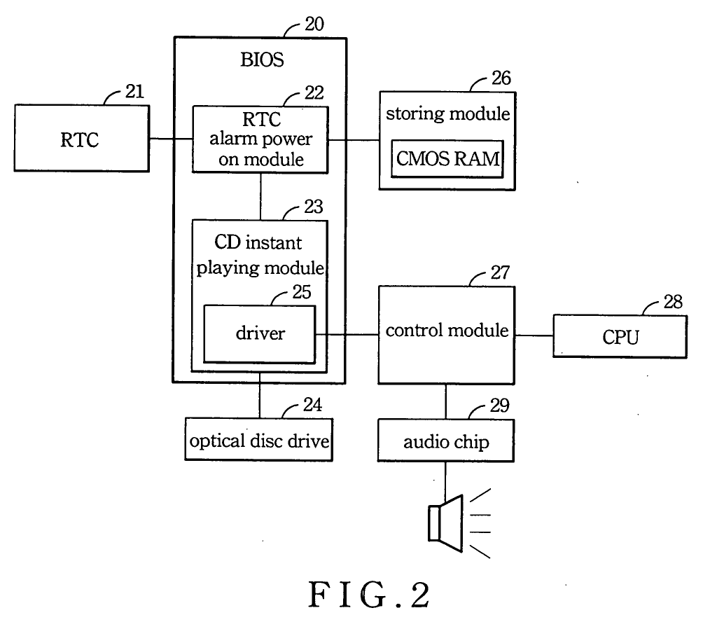

As mentioned above, the computer executes the method for playing instant music without loading the OS, but only setting and standing by the RTC and the CD instant playing module that can make computer maintain a least for working status so as to play a music disc. Referring to FIG. 2, when a BIOS 20 judges that the hardware time of an RTC 21 meets the predetermined start-up time, an RTC alarm power on module 22 boots the computer automatically. FIG. 2 illustrates a block diagram of a method for playing instant music in the present invention.

The BIOS 20 controls the operation of a CD instant playing module 23 which is a set of programs and provides a driver 25 for running an optical disc drive 24. Since the RTC alarm power on module 22 and the CD instant playing module 23 are two portions of the BIOS 20, which has an option to execute the RTC alarm power on module 22 and the CD instant playing module 23.

Besides, the predetermined start-up time set by the RTC alarm power on module 22 of the BIOS 20 is stored in the CMOS of a storing module 26. Then, the South Bridge Chip of a control module 27 proceeds the comparison of the hardware time and the predetermined start-up time of the RTC 21. When the BIOS 20 determines is activated by the RTC alarm power on module 22, the South Bridge of the control module 27 and a CPU 28 are initialized by the BIOS 20 first so as to make these components be under the state of starting up. Then, the BIOS 20 can initiate the optical disc drive 24 and an audio chip 29 through the South Bridge of the control module 27 to identify and set up the working states of these components. Since the CD instant playing module 23 includes a driver 25, and broadcasts the sound of the music CD by a speaker according to the control module 27 and the audio chip 29 of the BIOS 20.

No matter the hardware time or the predetermined start-up time set in advance, both will be stored in the CMOS. In another word, when the RTC alarm power on module is working, the CPU may determine and execute the related functions of the optical disc drive according to the predetermined start-up time of the CMOS.

Comparing the prior arts, the present invention are with merits listed below:
(1) Based on this invent, the optical disc derive of the computer can be applied to play music and vocal CDs without loading the OS. Due to that extra hardware and circuits are not necessary, the cost can be highly reduced.
(2) The present invention can replace the high-frequency traditional alarm noise with wonderful music. So the user can listen to the music at the beginning of a day, and can choose free types of music.
(3) The present invention can remind the user that the pre-set time is coming up by the special computer to replace the hi-fi equipment so as to save the space for placing the hi-fi equipment.
(4) Presently, the computer may be automatically booted up after loading the OS and complicate setting procedures, and it takes about or more than two minutes and thirty seconds; further, it takes another time period of one minute and thirty seconds or more to let the optical disc drive play CDs. Hence, the operating time is too long for customer demands. On the contrary, using the RTC and the instant music alarm, the user only spends two seconds to enter the BIOS and five seconds to drive the optical disc drive to play music or vocal CDs. Therefore, the design not only saves time, but also operates very easily.
(5) The window of the BIOS is operated very friendly and let the user arrange their schedule very straightforwardly.

As is understood by a person skilled in the art, the foregoing preferred embodiment of the present invention is illustrated of the present invention rather than limiting of the present invention. It is intended to cover various modifications and similar arrangements included within the spirit and scope of the appended claims, the scope of which should be accorded the broadest interpretation so as to encompass all such modifications and similar design.

What is claimed is:

1. A method for playing instant music, comprising the steps of:
generating a hardware time by reading a real time clock (RTC);
determining whether the hardware time meets a predetermined start-up time or not;
executing a BIOS, if the hardware time meets the predetermined start-up time;
determining whether a CD instant playing module of the BIOS is started or not;
initiating an optical disc drive and an audio module, if the CD instant playing module of the BIOS is started; and
playing the optical disc drive.

2. The method of claim 1, wherein the step of determining whether the CD instant playing module of the BIOS is started or not further comprises the step of determining whether an optional function of an RTC alarm power on module is started or not.

3. The method of claim 1, wherein the step of determining whether the CD instant playing module of the BIOS is started or not, while the CD instant playing module is not started, initiating system procedure and loading an operation system (OS).

4. The method of claim 1, wherein the hardware time and the predetermined start-up time are stored in a CMOS.

5. The method of claim 1, wherein the predetermined start-up time is input via the BIOS.

6. The method of claim 1, wherein the CD instant playing module is a set of programs providing a driver of the optical disc drive, the CD instant playing module is part of the BIOS, and there is an option in the BIOS to execute the CD instant playing module.

7. The method of claim 1, wherein if the hardware time meets the predetermined start-up time, the BIOS is executed so that the BIOS can issue an instruction to wake up a CPU and a chipset.

8. The method of claim 1, wherein the step of determining whether the hardware time meets the predetermined start-up time or not is processed under an S5 power-saving mode.

9. A computer applied to play a music disc, the computer comprising:
a real time clock (RTC) generating a hardware time;
an optical disc drive;
a BIOS having an RTC alarm power on module having a predetermined start-up time set therein and a CD instant playing module including a driving optical disc drive program, wherein the BIOS controls the operation of the RTC alarm power on module and the CD instant playing module;
a storing module for storing the BIOS and the predetermined start-up time; and
a control module driving the optical disc drive for playing the music disc if the hardware time meets the predetermined start-up time.

10. The computer of claim 9, wherein the storing module is a CMOS and the control module is a South Bridge Chip.
